(19) United States
(12) Patent Application Publication
(10) Pub. No.: US 2006/0212857 A1
(43) Pub. Date: Sep. 21, 2006

(54) Automated process for generating a build of a software application without human intervention

(75) Inventors: Douglas T. Neumann, Cary, NC (US); Brian D. Harry, Chapel Hill, NC (US); Sam Guckenheimer, Kirkland, WA (US); Alex A. Kipman, Duvall, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/085,346

(22) Filed: Mar. 21, 2005

(51) Int. Cl. G06F 9/45

(52) U.S. Cl. 717/140

(57) ABSTRACT

An “out-of-the-box” automated build process application capable of executing a build process without any human intervention. The automated build process application may be configured to be installed and executed without any intervening manual coding of the build process, and may be capable of being configured through a user interface. The automated build application may be integrated within a software development environment, eliminating the need to independently create and use non-integrated software tools and scripts to automate aspects of the build process. Embodiments of the invention may be implemented using a workflow engine configured to execute a build process. A workflow engine (e.g., the MSBuild engine available from Microsoft Corporation) can be configured to perform all of the acts involved in a build process. The build process may be defined by one or more files formatted in accordance with a markup language such as, for example, XML or HTML.

### BACKGROUND

In the software industry, it is generally considered a best practice for software developers (e.g., working in teams) to compile their applications in a clean and reproducible environment before releasing the application for in-depth testing or for use by users. This practice is important for reproducibility. That is, if later an issue (e.g., a bug or requested enhancement) arises with the application, it is important to be able to create a new build (i.e., version) that is identical to the previous build, except for any changes made to address the issue. For this reason, the ability to reproduce a build environment is a significant aspect of being able to reproduce a build of an application.

It is also generally considered a best practice to execute a build process in as automated a manner as feasible, with as little required human interaction as possible. As used herein, a “build process” includes at least compiling source code that defines an application to produce compiled code (e.g., one or more assemblies) that defines the application. A build process may include one or more additional steps or acts associated with the compiling of the source code such as, for example, executing acceptance tests. As used herein, an “automated build process” is a build process including a plurality of (e.g., two or more) acts that are performed independently of any intervening human actions. Human actions include, but are not limited to, entering a command (e.g., using a keyboard, mouse or other user input device), editing and/or manually launching a script or software tool, entering configuration information (e.g., through a user interface), and other human actions. Thus, human actions may take place before and/or after execution of an automated build process (e.g., a user scheduling or manually initiating the execution of the process), but there is no human intervention during the performance of the automated build process.

Automating a build process contributes to the reproducibility of a build because it eliminates the added variable of human error. Typically, to execute steps of a build in an automated manner, development teams manually code scripts and executables that perform the steps without human interaction.

It is further generally considered a best practice for software development teams to build their applications on a frequent basis. Doing so ensures that problems with a build (e.g., build breaks that prevent the build from generating completely) are discovered and addressed in a timely manner and that the source code for the application does not stray far from a buildable state. Many software development organizations execute their scripted build process on a nightly basis to achieve this practice. Additionally, some organizations will execute their scripted build process continually throughout the day or in association with each check-in of source code to a source control system.

Yet another practice generally considered a best practice is to execute a suite of acceptance tests on a build to ensure that it satisfies a minimum quality threshold (i.e., “scout” the build) before investing significant efforts into in-depth testing. Other organizations automate their acceptance tests and have them run as part of the actual build process. This practice eliminates the scout that can frequently be a bottleneck in the build and release process.

Despite the value of these best practices, many organizations do not implement them when executing a build process. Others implement them, but at considerable expense.

To reproduce a build environment, some organizations maintain one or more machines (e.g., the machine on which the build was generated) in the state of the build environment. Accordingly, to reproduce the build environment, the build may be executed on the one or more maintained machines. However, this is a costly technique for reproducing a build environment, and doesn't scale well as the cost may increase with the number of build environments maintained. Another technique for reproducing a build environment is for a developer to manually record build environment parameters, for example, by manually maintaining such information in a file. However, this technique is time consuming and prone to human error.

Further, automated build processes are usually manually coded from scratch with a series of scripts that piece together other tools for execution. These scripts can take several weeks of dedicated development time to create. Further, automated build processes are typically not subjected to the same testing rigor as the applications to which they are applied during the build process, and therefore are more likely to break. These breaks incur maintenance costs. Also, maturing organizations frequently identify additional requirements of their build system that must be back-engineered into the system. This back-engineering also incurs maintenance costs on the system.

Further, automated build processes often leverage different build tools than those used by developers on their desktops to develop applications. For example, developers frequently work in a rich Integrated Development Environment (IDE) such as, for example, Microsoft® Visual Studio® (MVS). Because these rich applications frequently are not capable of being scripted, automated build processes often must leverage different tools. That is, build process scripts and executables are manually coded by developers independently of the software development applications being used. As a result, modules of an application that compile without problems on a particular developer's desktop may break during the automated build process, requiring an investigation that consumes human resources of the team.

### SUMMARY

Described herein are improved systems and methods for executing a build process in an automated manner.

The systems and methods described herein may include providing an “out-of-the-box” automated build process application capable of executing a build process without any human intervention. The automated build process application may be executed following installation (e.g., on a developer's computer) without any intervening manual coding (e.g., of scripts or executables). In some embodiments, the build process application may be capable of being additionally configured (e.g., by a developer or other person), for example, through a user interface (e.g., a wizard), where values are provided for one or more user-definable parameters.

The automated build application may be integrated within a software development environment (e.g., an IDE), eliminating the need to independently create and use non-integrated software tools and scripts to automate aspects of the build process. Such an integrated, automated build process may achieve improved reproducibility and efficiency, and reduced cost over known build processes.

In some embodiments of the invention, the build process application may define two or more of the following acts, to be performed sequentially (not necessarily in the following order), independently of any intervening human action: recording values of build environment parameters; acquiring source code of the software application; generating a unique identifier for the build; compiling source code into compiled code (e.g., one or more assemblies) defining the build (i.e., “compiling the build” or “generating the build”); analyzing (i.e., performing static tests on) the source code and/or the compiled code for one or more particular problems (e.g., known common problems); performing one or more tests on the build (e.g., to determine whether the build satisfies one or more quality thresholds); determining one or more code portions of the source code that are tested by the one or more tests (i.e., determining “code coverage”); updating one or more work items affected by the build; determining an extent of change between the build and a previous build (i.e., determining “code churn”); and generating a build report based on, and possibly including, information recorded during execution of the build process (e.g., as part of any of the proceeding acts).

In some embodiments, one or more (e.g., all) of the acts of the build process are integrated within a software development environment (e.g., IDE) used to develop the software application of the build. For example, systems and methods for executing the automated build process may be implemented as part of MVS.

In some embodiments, tests to be run on generated builds are version controlled, in that each version of the source code from which a build is generated has a corresponding version of tests to be run on the build. Metadata defining the relationships between the versions of source code and tests may be maintained (e.g., in an XML file). The automated build process application may be configured to access the test versions and metadata to run one or more tests on a build.

Embodiments of the invention may be implemented using a workflow engine configured to execute a build process. A workflow engine or workflow application aids in tracking and managing activities involved in a project from start to finish. Thus, a workflow engine can be configured to perform all of the acts involved in a build process from start to finish such as, for example, one or more of the acts described herein. For example, in some embodiments of the invention, a build process may be implemented using the MSBuild engine available from Microsoft Corporation. MSBuild is described on Microsoft's MSDN website at: http://lab.msdn.microsoft.com/vs2005/teams/msbuild/default.aspx (the MSBuild website) as of the date of filing of this application, and is described in further detail in Appendix I: Overview of MSBuild, Part 1: From a Project Author's Perspective; Appendix II: Overview of MSBuild, Part 2: From the TaskAuthor's Perspective; Appendix III: Overview of MSBuild, Part 3: What is the Limit to Extensibility? The contents of Appendices I-III and the MSBuild website are hereby incorporated by reference in their entirety.

In some embodiments, for example, embodiments in which MSBuild is used, the build process may be defined by one or more files formatted in accordance with a markup language such as, for example, XML, as described below in more detail in relation to FIG. 3.

In an embodiment of the invention, an automated build process is implemented for one or more software applications. A build process application defining the automated build process is installed on the computer system. The automated build process comprises: (i) acquiring source code defining a software application; (ii) compiling the source code into compiled code defining a build of the software application; (iii) recording values of build environment parameters at a time of the compiling; (iv) performing one or more tests on the build to determine whether the build satisfies one or more particular quality thresholds; and (v) generating a report based on information resulting from at least performance of the acts (iii) and (iv). On the computer system, the execution of the automated build process for a first software application is controlled using the build process application.

In an aspect of this embodiment, the build process application has one or more user-definable parameters, and the build process application defines a user interface enabling a user to define values for one or more parameters of the automated build process. The one or more parameters are configured by executing the user interface.

In another aspect of this embodiment, the build process application is configured to be capable of executing the automated build process after installation without any manual coding. Controlling the execution is performed after the installation without any intervening manual coding of the automated build process.

In another aspect of this embodiment, the performing of the one or more tests includes performing at least one test corresponding to a version of the source code from which the build was compiled.

In yet another aspect of this embodiment, the automated build process defined by the build process application further comprises an act of (vi) analyzing the source code and/or the compiled code for one or more particular problems.

In another aspect of this embodiment, the automated build process defined by the build process application further comprises an act of (vi) determining one or more portions of the source code that are tested as part of the act (iv).

In another aspect of this embodiment, the automated build process defined by the build process application further comprises an act of: (vi) determining an extent of change between the build and a previous build.

In yet another aspect of this embodiment, the automated build process defined by the build process application further comprises an act of: (vi) updating one or more work item abstractions affected by the build.

In another aspect of this embodiment, the automated build process defined by the build process application further comprises acts of: (vii) analyzing the source code and/or the compiled code for one or more particular problems; (viii) determining one or more portions of the source code that are tested as part of the act (iv); and (ix) determining an extent of change between the build and a previous build.

In yet another aspect of this embodiment, on the computer system, the build process application is executed for a second software application.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs. The computer-readable signals may define one or more of the instructions in accordance with a mark-up language.

In another embodiment of the invention, a system is provided for implementing an automated build process for one or more software applications. The system comprises a build process application operative to execute an automated build process comprising: (i) acquiring source code defining a software application, (ii) compiling the source code into compiled code defining a build of the software application, (iii) recording values of build environment parameters at a time of the compiling, (iv) performing one or more tests on the build to determine whether the build satisfies one or more particular quality thresholds, and (v) generating a report based on information resulting from at least performance of the acts (iii) and (iv). The build process application is configured to be installed and executed on a computer system without any intervening manual coding of the automated build process.

In an aspect of this embodiment, the build process application has one or more user-definable parameters, and the build process application defines a user interface enabling a user to define values for one or more parameters of the automated build process.

In another aspect of this embodiment, the automated build process application is operative to perform at least one test corresponding to a version of the source code from which the build was compiled.

In another aspect of this embodiment, the automated build process defined by the build process application further comprises an act of analyzing the source code and/or the compiled code for one or more particular problems.

In another aspect of this embodiment, the automated build process defined by the build process application further comprises an act of determining one or more portions of the source code that are tested as part of the act (iv).

In yet another aspect of this embodiment, the automated build process defined by the build process application further comprises an act of determining an extent of change between the build and a previous build.

In another aspect of this embodiment, the automated build process defined by the build process application further comprises an act of updating one or more work item abstractions affected by the build.

In another aspect of this embodiment, the automated build process defined by the build process application further comprises acts of analyzing the source code and/or the compiled code for one or more particular problems; determining one or more portions of the source code that are tested as part of the act (iv); and determining an extent of change between the build and a previous build.

In another aspect of this embodiment, the automated build process application is configurable to execute the build process for a plurality of different software applications.

In another embodiment of the invention, a build process for a software application is executed. On a computer system at a first time, source code defining the software application is compiled into compiled code defining a build of the software application. Values of build environment parameters at the first time are recorded. The acts of recording and compiling are independently of any intervening human action.

In an aspect of this embodiment, the source code and/or the compiled code are analyzed for one or more particular problems, and the acts of compiling, recording and analyzing are performed independently of any intervening human action.

In another aspect of this embodiment, one or more tests are performed on the build to ensure the build satisfies one or more particular quality thresholds, and the compiling, the recording and the performance of the one or more tests are performed independently of any intervening human action.

In another aspect of this embodiment, one or more portions of the source code that are tested as part of the tests are determined, and the compiling, the recording, the performance of the one or more tests and the determining are performed independently of any intervening human action.

In another aspect of this embodiment, an extent of change between the build and a previous build is determined, and the acts of compiling, recording and determining are performed independently of any intervening human action.

In yet another aspect of this embodiment, one or more work item abstractions affected by the build are updated, wherein the acts of compiling, recording and updating are performed independently of any intervening human action.

In another aspect of this embodiment: the source code and/or the compiled code are inspected for one or more particular problems; one or more tests are performed on the build to determine whether the build meets particular quality thresholds; one or more portions of the source code that are tested as part of the tests is determined; and an extent of change between the build and a previous build is determined, and the acts of compiling, recording, updating, performing one or more tests, determining one or more portions and determining the extent of change are performed independently of any intervening human action.

In another aspect of this embodiment, information determined as part of performance of one or more of the acts of compiling, recording, updating, performing one or more tests, determining one or more portions and determining the extent of change is recorded, and one or more reports are generated based on this recorded information.

In another aspect of this embodiment, the build process is defined in one or more files formatted in accordance with a mark-up language, and the one or more files are processed.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs. The computer-readable signals may define one or more of the instructions in accordance with a mark-up language.

In another embodiment of the invention, a system for executing a build process for a software application is provided. The system includes a compiler to compile, on a computer system at a first time, source code defining the software application into compiled code defining a build of the software application. The system also includes a recording module to control recording values of build environment parameters at approximately the first time, and a controller to control the compiler and the recording module to compile and control the recording, respectively, independently of any intervening human action.

In an aspect of this embodiment, the system includes a code-analyzing module to analyze the source code and/or the compiled code for one or more particular problems, and the controller is operative to control the compiler, recording module and code-analyzing module to compile, control the recording and analyze, respectively, independently of any intervening human action.

In another aspect of this embodiment, the system includes a testing module to perform one or more tests on the build to determine whether the build satisfies one or more particular quality thresholds, and the controller is operative to control the compiler, recording module and testing module to compile, control the recording and perform the one or more tests, respectively, independently of any intervening human action.

In another aspect of this embodiment, the system includes a code coverage module to determine one or more portions of the source code that were tested by the testing module, and the controller is operative to control the compiler, recording module, testing module and code coverage module to compile, control the recording, perform the one or more tests and determine the one or more portions, respectively, independently of any intervening human action.

In another aspect of this embodiment, the system includes a code-churning module to determine an extent of change between the build and a previous build, and the controller is operative to control the compiler, recording module and code-churning module to compile, control the recording and determine the extent of change, respectively, independently of any intervening human action.

In yet another aspect of this embodiment, the system includes a report generating module to generate one or more reports based on the recorded values of the build environment parameters.

In another aspect of this embodiment, the system includes a file formatted in accordance with a mark-up language, the file defining the build process, and the controller is operative to process the file to execute the build process.

In another aspect of this embodiment, the system is integrated as part of an integrated development environment.

In another aspect of this embodiment, the system includes a user interface to enable a user to configure one or more aspects of the build process.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a flowchart illustrating an example of a method of implementing an automated build process, according to some embodiments of the invention;

FIG. 2 is a flowchart illustrating an example of a method of executing an automated build process, according to some embodiments of the invention;

FIG. 3 is a block diagram illustrating an example of a system for executing an automated build process, according to some embodiments of the invention;

FIG. 4 is a block diagram illustrating an example of a distributed system for executing an automated build process, according to some embodiments of the invention;

FIG. 5 is a block diagram illustrating an example of a computer system on which some embodiments of the invention may be implemented; and

FIG. 6 is a block diagram illustrating an example of a storage system that may be used as part of the computer system to implement some embodiments of the invention.

### DETAILED DESCRIPTION

The function and advantage of embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

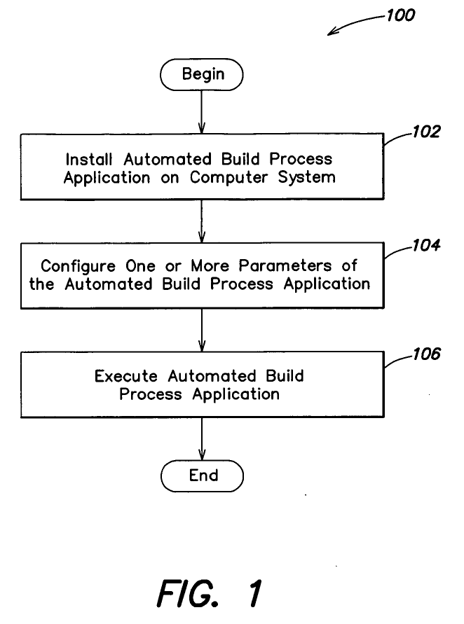

FIG. 1 is a flowchart illustrating an example of a method 100 of implementing an automated build process on a computer system. Method 100 is merely an illustrative embodiment of a method for implementing an automated build process, and is not intended to limit the scope of the invention. Any of numerous other implementations of such a method, for example, variations of method 100, are possible and are intended to fall within the scope of the invention. Method 100 or one or more acts thereof may be implemented using one or more of systems 300-600 described below.

In Act 102, an automated build process application may be installed on a computer system. For example, the automated build process application may be installed from one or more disks or from downloading it over a network connection. The automated build process application may be configured in accordance with MSBuild available from Microsoft Corporation, for example, as described below in relation to Appendices I-III and/or the MSBuild website.

In Act 104, one or more parameters of the automated build process application may be configured, for example, by a software developer or a build administrator. For example, a user interface (e.g., a wizard) may be provided to enable a user (e.g., a software developer or a build administrator) to configure one or more user-definable parameters of the build process defined by the build process application.

As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces. As used herein, the visual presentation of information presented by a user interface or GUI is referred to as a “user interface display” or a “GUI display,” respectively.

The user interface may enable to select a previously defined build process configuration for a build process and modify the selected build process configuration by adding, changing or deleting values of user-definable parameters, and/or create a new build process configuration. The user-definable parameters of a build configuration may include parameters for defining: a name and/or other unique identifier for the build process configuration; a description of the build process configuration; and owner of the build process configuration; a work space; a build machine and/or build directory on which the build process is to be executed; a build drop location at which to store the build (e.g., one or more assemblies) generated from the execution of the build process; as well as other parameters.

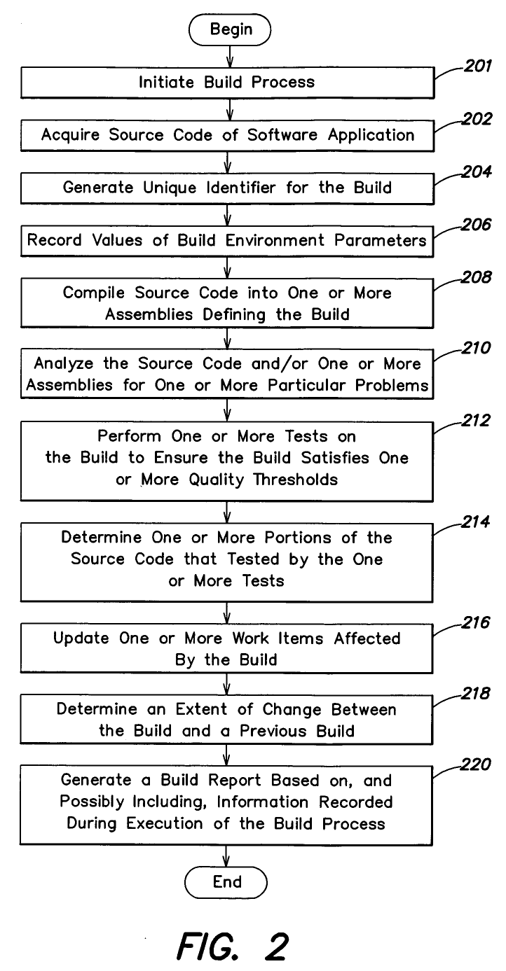

The user interface also may be configured to enable a user to configure one or more acts to be performed as part of the build process (e.g., as part of a build process definition). For example, a user interface may provide a display that lists one or more acts (e.g., any of the acts described below in relation to FIG. 2) and enables the user to select/deselect one or more of the acts for a particular build process.

Further, as part of Act 104, a user interface may be configured to enable a user to define a schedule of one or more times at which to execute the build process, which may be stored as part of a build process configuration. For example, one or more fields may be provided on a display, enabling a user to specify a particular date and time at which to start the build, and may enable a user to specify a recurrence pattern. For example, the user may specify that the build process is to be performed daily, bi-daily, weekly, bi-weekly, monthly, or specify another recurrence pattern.

In Act 106, the automated build process application may be executed, for example, as described below in relation to FIG. 2. Act 106 may be performed after installation of the automated build process in Act 102 without any intervening manual coding (e.g., scripts or executables) of the build process application. However, it should be appreciated that in some embodiments the automated build process application may be configured so that one or more aspects thereof may be manually coded after installation.

Method 100 may include additional acts. Further, the order of the acts performed as part of method 100 is not limited to the order illustrated in FIG. 1, as the acts may be performed in other orders and/or one or more of the acts may be performed in series or in parallel, at least partially. For example, Act 104 may be performed after Act 106, before the build process is executed again. For example, a build process definition may be modified between execution of the build process.

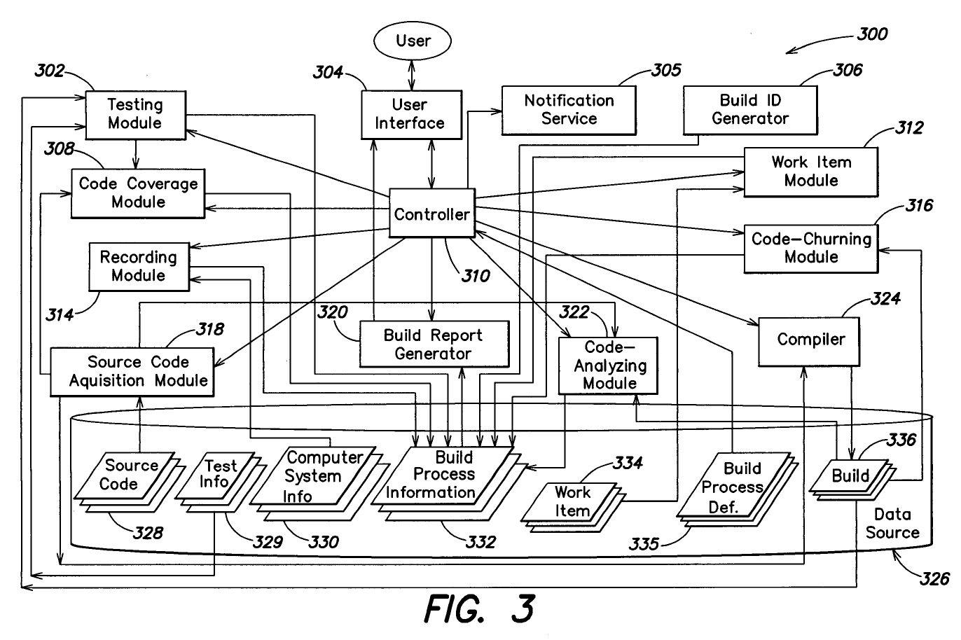

FIG. 2 is a flowchart illustrating an example of a method 200 of executing an automated build process. Method 200 is merely an illustrative embodiment of a system for executing an automated build process, and is not intended to limit the scope of the invention. Any of numerous other implementations of such a method, for example, variations of method 200, are possible and are intended to fall within the scope of the invention. Method 200 may include any of Acts 202-220 described below, and may be implemented using any of systems 300-600 described below in relation to FIGS. 3-6.

In Act 201, the build process may be initiated. The build process may be initiated manually, for example, by a user entering a command through a user interface (e.g., by simply clicking on a button). Alternatively, the build process may be initiated automatically at a prescheduled time such as, for example, a time configured by a user through a user interface as part of Act 104. Act 201 may be controlled by controller 310 described below in relation to FIG. 3 and/or the component of system 300 of FIG. 3 that is the first component of system 300 to perform an action as part of executing an automated build process.

In Act 202, source code of the software application may be acquired. For example, the source code may be pulled from a centralized source code repository of a source control system, which may be specified by a user in Act 104. Act 202 may be performed by source code acquisition module 318 of system 300 described below in relation to FIG. 3.

In Act 204, a unique identifier may be generated for the build. This unique identifier may be used to associate inputs, outputs and other information with the build. Act 204 may be executed by build ID generator 306 of system 300 described below in relation to FIG. 3.

In Act 206, values of build environment parameters, (e.g., any of those described herein) are recorded. As used herein, a “build environment parameter” is a parameter or property of a computing environment at a time at which the build is compiled (or immediately preceding or proceeding such time). Build environment parameters include, but are not limited to: software tool parameters and platform parameters. Software tool parameters may include parameters relating to the software tools used to execute the build process. These parameters may include the names, versions and other information about the software tools used. Platform parameters may include any parameters relating to the platform on which the build process was executed. Such parameters may include parameters relating to the microprocessor, operating system, versions of NET framework, other software operating on the machine at the time of the execution of the build process, .COM objects installed on the machine at the time of the execution of the build process; the contents of an operating system registry (e.g., one of the operating systems available from Microsoft systems listed below); hardware configuration parameters (e.g., network cards, machine configuration, other cards, etc.). Recording the values of the build environment parameters may allow the build environment to be recreated later. Act 206 may be performed by recording module 314 of system 300 described below in relation to FIG. 3.

In Act 208, the source code of the application may be compiled into compiled code (e.g., one or more assemblies) defining the build. As used herein, an “assembly” is a collection of one or more files that are versioned and deployed as a unit. For example, an assembly may be a building block of a .NET framework application. The source code may be coded in any of a variety of programming languages, including object-oriented programming languages, such as, for example, any suitable programming languages of the programming languages described herein. Further, the source code may be compiled using any of a variety of known compilers, and may be compiled by compiler 324 of system 300 described below in relation to FIG. 3.

In Act 210, the source code and/or the compiled code may be analyzed to determine if either has one or more particular problems (e.g., known common problems). That is, static analysis may be performed to identify potential issues by inspecting the source code and/or assemblies. Any of a variety of known analysis techniques may be used. The results of the analysis, including any discovered problems or errors, may be recorded and included in a build report (e.g., the build report generated in Act 220 below). Act 210 may be performed by code-analyzing module 322 of system 300 described below in relation to FIG. 3.

In Act 212, one or more tests are performed on the build to ensure that the build satisfies one or more performance thresholds. Any of a variety of known tests may be applied, and the results of these tests (e.g. success, failure) may be recorded and included in a build report (e.g., the build report generated in Act 220 below). These tests may include test versions corresponding to the source code compiled (i.e., version-controlled tests) such as, for example, as described in pending U.S. patent application Ser. No. 10/822,454, titled “Version Aware Test Management System and Method” by Sam Guckenheimer and Erez Haba, filed Apr. 12, 2004 (the Guckenheimer application), the entire contents of which are hereby incorporated by reference in its entirety. Act 212 may be performed by testing module 302 of system 300 described below in relation to FIG. 3.

In Act 214, the one or more portions of the source code that are tested by the one or more tests performed in Act 212 may be determined. That is, the code covered by the one or more tests of Act 212 may be calculated, giving an indication of how much of the application was tested during the build process. For example, the calculated code coverage may specify any of: a percentage of code blocks hit by the test; a percentage missed; and a percentage partially hit. This information may be recorded and included in a build report (e.g., the build report generated in Act 220 below). Act 214 may be performed by code coverage module 308 of system 300 described below in relation to FIG. 3.

In Act 216, one or more work items affected (e.g., resolved, created or otherwise affected) by the build may be updated. As used herein a “work item” is an abstraction representing a unit of work. A work item may include an identifier and one or more other properties such as, for example, a description of the work item, a type of the work item (e.g., bug, feature on the etc.), builds that effect the work item, and other properties. Act 216, may include updating one more work item(s) to reflect that a build effects the work item such as, for example, addresses the issue defined by the work item. Updating a work item may include creating a work item based on the results of (e.g., errors encountered) in any of Acts 208-214. This information may be recorded and included in a build report (e.g., the build report generated in Act 220 below). Act 216 may be performed by work item module 312 of system 300.

In Act 218, an extent of change between the build and a previous build may be determined. That is, code-churn data may be calculated between the build and the previous build. The code churn data may indicate the number of lines of code added, the number of lines modified and the number of lines deleted, among other information. Any of a variety of known techniques may be used to calculate this code-churn data. The code-churn data may be recorded and included in a build report (e.g., the build report generated in Act 220 below). Act 218 may be performed by code-churning module 316 of system 300 described below in relation to FIG. 3.

In Act 220, a build report may be generated based on, and possibly including, information recorded during the execution of the build process. That is, during the performance of any of the Acts of method 200, information corresponding to one or more of the acts may be recorded. Act 220 may be performed at any time during execution of the build process, so that some of the reported information may be indicative of the status of the currently executing build process, as opposed to information of a completed build process. Information reported in Act 220 may include general information, errors and warnings (e.g., resulting from compilation and static analysis); test results of any test run on the build; code coverage results (i.e., results of Act 214) such as percentage of blocks of code missed, hit, and partially hit; code-churn information (e.g., information resulting from performance of Act 218) such as, for example, number of lines of code added, number of lines of code modified and number of lines of code deleted between the build and the previous build; work items resolved by the build; and work items that may have been created due to one or more failures of the build. The general information may include: the build number, the portfolio project corresponding to the build (e.g., in MVS); the status of the build (e.g., initializing, started, getting sources from source control, started compilation, compilation completed, started testing, test completed, dropping build to drop site, build completed with success, build completed with failures, build aborted, etc.); a quality indicator of the build (e.g., unexamined, rejected, under investigation, ready for initial test, initial test passed, lab test passed, ready for deployment, released, other quality indicators); start/end time; a drop location indicator indicating a link which points to the compiled code which are copied when the build completes; log location indicator which indicates a link to a location where build logs will be available; a label applied to the source; change sets associated with the build; the name of the configuration used for the build; build machine, build types (e.g., “on demand” or “scheduled”), or other general information.

In another act (not shown), the build may be published, for example, to one or more servers.

As will be described in more detail below, method 200, including one or more of the acts described above, may be defined in a file, for example, a file formatted in accordance with a mark-up language such as HTML, XML or another mark-up language. Method 200 may be implemented by processing such a file the definition in the file, for example, using a workflow engine such as MSBuild.

Method 200 may include additional acts. Further, the order of the acts performed as part of method 200 is not limited to the order illustrated in FIG. 2, as acts may be performed in other orders and/or one or more of the acts may be performed in series or in parallel, at least partially. For example, any of Acts 206, 210, 212, 216 and 218 may be performed in parallel or in series in a different order than that shown in FIG. 2.

Methods 100 and 200, acts thereof and various embodiments and variations of this method and these acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer-readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., method 100 or 200 or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 300-600 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 3-6, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

FIG. 3 is a block diagram illustrating an example of a system 300 for executing an automated build process application. System 300 is merely an illustrative embodiment of a system for executing an automated build process and is not intended to limit the scope of the invention. Any of numerous other implementations of such a system, for example, variations of system 300, are possible and are intended to fall within the scope of the invention.

System 300 may include any of: testing module 302; user interface 304; notification service 305; build ID generator 306; code coverage module 308; controller 310; work item module 312; recording module 314; code-churning module 316; source code acquisition module 318; build report generator 320; code-analyzing module 322; compiler 324, a build publishing module (not show) and data source 326.

Data source 326 may be any of a plurality of types of data sources such as, for example, a database (e.g., relational database, an object-oriented database, a file system, or any suitable combination of the forgoing). Data source 326 may store thereon any of: source code 328; test information 329; build environment information (e.g., including computer system information 330), build process information 332, one or more work item abstractions 334, one or more build process definitions (e.g., in one more files formatted in accordance with a mark-up language) 335; one or more builds 336, other information and any suitable combination of the foregoing. It should be appreciated that any one or more of the foregoing elements that may be stored in data source 326 may be stored on different data sources, which may be remotely located from one another on different machines. For example, source code 328 may be stored in a source code depository remotely disposed from data source 326.

Testing module 302 may be configured to access and test one more builds 336, for example, as described above in relation to Act 212 of method 200, and generate test results that may be stored as part of build process information 332. In some embodiments, testing module may be configured to access test information 329 that specifies information about the tests to be performed on the build. Test information may include information defining version-specific tests that correspond to particular versions of source code, and metadata defining the relationships between test versions and source code versions. Testing module 302 may be configured to use such test information to apply one or more version-specific tests on the compiled build, for example, as described in the Guckenheimer application.

Code coverage module may be configured to access source code 328 from source code acquisition module 318 and test parameters from testing module 302, and determine one or more portions of the source code that were tested by the tests, for example, as described above in relation to Act 214 of method 200. The results of this determination may be stored as part of build process information 332.

Recording module 314 may be configured to access build environment information (e.g., computer system information 330), and record this information as part of build process information 332, for example, as described above in relation to Act 206 of method 200.

Source code acquisition module 318 may be configured to acquire source code 328, for example, as described above in relation to Act 202 of method 200.

Build report generator 320 may be configured to generate one or more build reports from the build process information 332, for example, as described above in relation to Act 220 of method 200. Report generator 320 may be configured to interact with user interface 304 so that a build report may be displayed to, and navigated by, a user.

Code-analyzing module may be configured to analyze source code 328 (e.g., provided by module 318) and/or compiled code of one or more builds 336, and record this information as part of build process information 332, for example, as described above in relation to Act 210 of method 200.

Compiler 324 may be configured to compile source code 328 (e.g., received from module 318) into compiled code of one or more builds 336, for example, as described above in relation to Act 208 of method 200. Further, compiler 324 may be configured to record any problems or errors in compiling the source code (e.g., a build break) as part of build process 332.

Code-churning module 316 may be configured to determine an extent of change between two builds of builds 336, and record the results of this determination as part of build process information 322, for example, as described above in relation to Act 218 of method 200.

Work item module 312 may be configured to update (including creating if necessary) any work items 334 affected by a build and record this information as part of build process information 322, for example, as described above in relation to Act 216 of method 200.

Notification service 305 may be configured to initiate notifications of events associated with the execution of a build process (e.g., build completed, build failed, etc.) to other processes and email pumps (i.e., email services that generate, format and send emails to designated recipients). The notification service 305 may be configured to send such notifications based on instructions received from controller 310. Act 200, described above in relation to FIG. 2, may include one or more acts of sending notifications of events that occur in response to performance of any of the acts of method 200.

Build ID generator 306 may be configured to generate IDs for builds 336 and record this information as part of build process information 322, for example, as described above in relation to Act 204 of method 200.

User interface 304 may be configured to enable a user to configure one or more parameters of a build process, for example, as described above in relation to Act 104 of method 100. Further user interface may be configured to display build reports to users and enable users to navigate the build reports.

Controller 310 may be configured to control execution of a build process by controlling one or more of components 302-308 and 312-324 to perform their function in a particular sequence. For example, the controller 310 may be configured to access a build process definition (e.g., one of definitions 335) and execute the build process in accordance with the definition. In some embodiments, controller 310 may be implemented as a work flow engine such as, for example, MSBuild available from Microsoft Corporation. In such embodiments the build process definition may be in the form of one or more files formatted in accordance with a mark-up language. For example, controller 310 may be configured to executed a build process in accordance with any of Appendices I-III or a suitable combination thereof.

For example, with reference to Appendices I-III, a Project file (e.g., in XML defining a build process may be provided. For each act (e.g., any of the acts of method 200) included in the build process, one or more Targets may be defined in the Project file, each Target including one or more Tasks. The input required by each act may be defined as an Item in the Project file. Each Target may specify a dependency to another Target indicating that the other target must be performed first. By defining dependencies between a plurality of Targets, an order of acts or steps to be performed as part of build process may defined. That is, a plurality of acts may be chained together. For example, a Project file may include a plurality of Targets defining dependencies that together define a build process that performs Acts 202-220 in the order shown in FIG. 2. The MSBuild build engine may execute the build process by processing the Project File. For example, a call may be made to a Target of the Project file representing a last act of a build process (e.g., the act of publishing the build in method 200). This Target may define a dependency to a Target defining another Act (e.g., Act 220 of generating a build report) that must be executed before the current Target. The Target for Act 220 may specify a dependency to a Target for Act 218, and so on, until the beginning of the build process. Thus, the dependencies defined by the Targets of the Project file may be configured such that, by calling a Target for a last act of a build process, the complete build process is performed from its beginning.

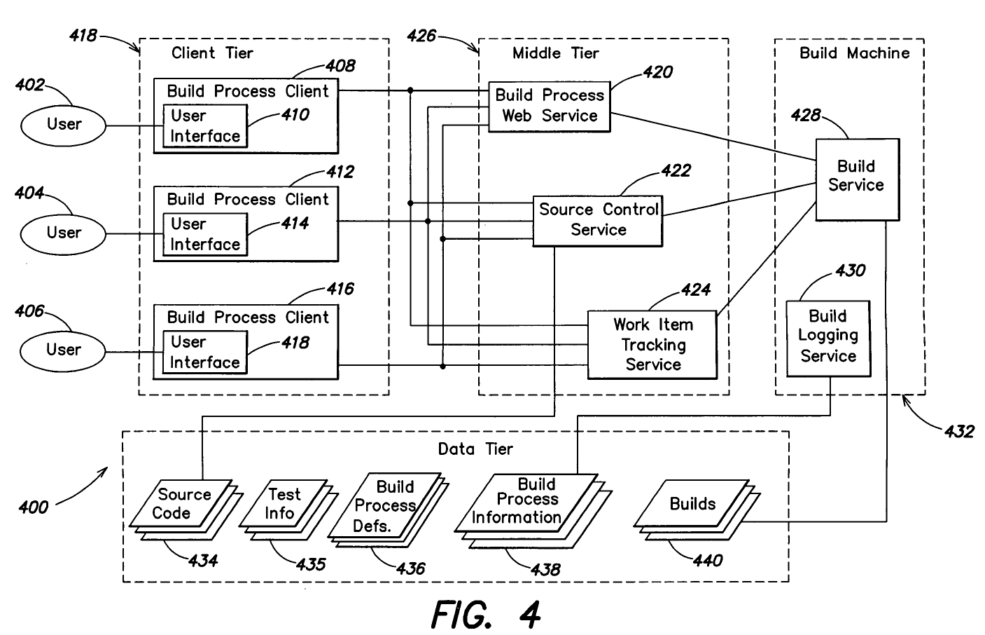

FIG. 4 is a block diagram illustrating an example of a distributed system 400 for executing an automated build process, for example, in accordance with the Team Foundation architecture available from Microsoft Corporation. System 400 is merely an illustrative embodiment of a distributed system for executing an automated build process and is not intended to limit the scope of the invention. Any of numerous other implementations of such a system, for example, variations of system 400, are possible and are intended to fall within the scope of the invention.

System 400 may be considered to have a multi-tiered architecture including: a client tier 418, middle tier 426, build machine 428 and data tier 442. The client tier 418 may include multiple build process clients 408, 412 and 416, which each may reside on a same or different machine. Each build process client 408, 412 and 416 may include a user interface 410, 414 and 418, respectively, for interfacing with respective users 402, 404 and 406. For example, one or more user interfaces 402, 404 and 406 may be implemented in accordance with user interface 304 described above in relation to FIG. 3. The configuration of a build process, displaying of a build report and/or initiating of a build process may be executed by one or more of user interfaces 402, 404 and 406.

The middle tier may include any of: build process web service 420, source control service 422, work item tracking service 424 and other elements. Build process web service 420 may be configured to accept requests from build process clients (e.g., clients 408, 412 and 416) and coordinate the execution of acts of a build process. In some embodiments, web service 420 may be configured to implement one or more (e.g., all) aspects of controller 310 of system 300, and may execute a build process in accordance with a build process definition 436. Executing a build process may include accessing, at various stages, source code 434, test information 435, builds 440 and build process information 438. Source control service may be configured to coordinate the use or the source code 434 by one or more developers (e.g., 402-406) for example, as part of the build process. Work item tracking service may be configured to track work items, and may be utilized as part of the build process when updating work items as described above.

Build machine 428 may include any of: build service 428, build logging service and other elements. Build service 428 executes the build steps in response to instructions received from the team build web service, resulting in one or more builds 438. In some embodiments, web service 420 may be configured to implement aspects of one or more of the elements 302, 306, 308 and 312-324 of system 300. Build logging service 430 may be configured to log information generated during the execution of a build process as build process information 438.

Systems 300 and 400 and components thereof, may be implemented using any of a variety of technologies, including software (e.g., C, C#, C++, Java, or a combination thereof), hardware (e.g., one or more application-specific integrated circuits), firmware (e.g., electrically-programmed memory) or any combination thereof. One or more of the components of systems 200 and/or 300 may reside on a single device (e.g., a computer), or one or more components may reside on separate, discrete devices. Further, each component may be distributed across multiple devices, and one or more of the devices may be interconnected.

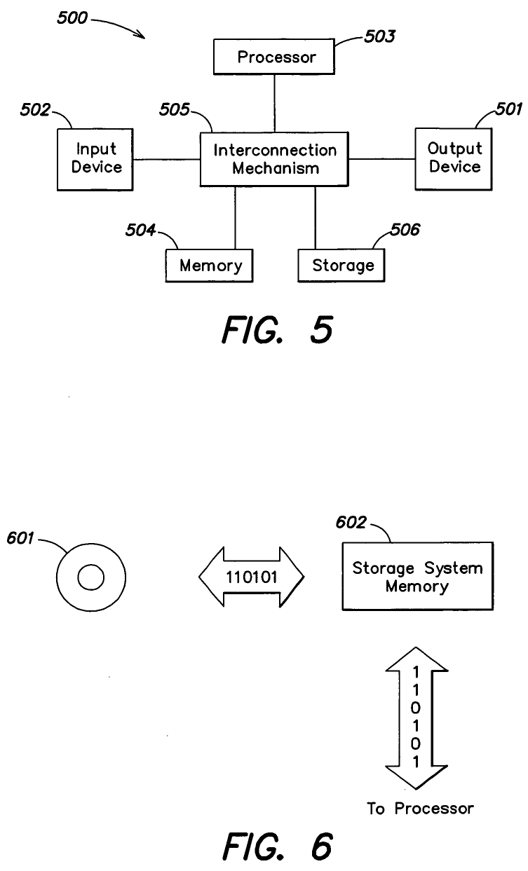

Further, on each of the one or more devices that include one or more components of systems 300 and/or 400, each of the components may reside in one or more locations on the system. For example, different portions of the components of these systems may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. Systems 300 and/or 400, and components thereof, may be implemented using a computer system such as that described below in relation to FIGS. 5 and 6.

Various embodiments according to the invention may be implemented on one or more computer systems. These computer systems, may be, for example, general-purpose computers such as those based on Intel PENTIUM-type processor, Motorola PowerPC, Sun UltraSPARC, Hewlett-Packard PA-RISC processors, any of a variety of processors available from Advanced Micro Devices (AMD) or any other type of processor. It should be appreciated that one or more of any type of computer system may be used to implement various embodiments of the invention.

A general-purpose computer system according to one embodiment of the invention is configured to perform one or more of the functions described above. It should be appreciated that the system may perform other functions and the invention is not limited to having any particular function or set of functions.

For example, various aspects of the invention may be implemented as specialized software executing in a general-purpose computer system 500 such as that shown in FIG. 5. The computer system 500 may include a processor 503 connected to one or more memory devices 504, such as a disk drive, memory, or other device for storing data. Memory 504 is typically used for storing programs and data during operation of the computer system 500. Components of computer system 500 may be coupled by an interconnection mechanism 505, which may include one or more busses (e.g., between components that are integrated within a same machine) and/or a network (e.g., between components that reside on separate discrete machines). The interconnection mechanism 505 enables communications (e.g., data, instructions) to be exchanged between system components of system 500. Computer system 500 also includes one or more input devices 502, for example, a keyboard, mouse, trackball, microphone, touch screen, and one or more output devices 501, for example, a printing device, display screen, speaker. In addition, computer system 500 may contain one or more interfaces (not shown) that connect computer system 500 to a communication network (in addition or as an alternative to the interconnection mechanism 505.

The storage system 506, shown in greater detail in FIG. 6, typically includes a computer readable and writeable nonvolatile recording medium 601 in which signals are stored that define a program to be executed by the processor or information stored on or in the medium 601 to be processed by the program. The medium may, for example, be a disk or flash memory. Typically, in operation, the processor causes data to be read from the nonvolatile recording medium 601 into another memory 602 that allows for faster access to the information by the processor than does the medium 601. This memory 602 is typically a volatile, random access memory such as a dynamic random access memory (DRAM) or static memory (SRAM). It may be located in storage system 506, as shown, or in memory system 504, not shown. The processor 503 generally manipulates the data within the integrated circuit memory 504, 1602 and then copies the data to the medium 601 after processing is completed. A variety of mechanisms are known for managing data movement between the medium 601 and the integrated circuit memory element 504, 602, and the invention is not limited thereto. The invention is not limited to a particular memory system 504 or storage system 506.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 500 is shown by way of example as one type of computer system upon which various aspects of the invention may be practiced, it should be appreciated that aspects of the invention are not limited to being implemented on the computer system as shown in FIG. 5. Various aspects of the invention may be practiced on one or more computers having a different architecture or components that are shown in FIG. 5.

Computer system 500 may be a general-purpose computer system that is programmable using a high-level computer programming language. Computer system 500 also may be implemented using specially-programmed, special-purpose hardware. In computer system 500, processor 503 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from the Microsoft Corporation, MAC OS System X available from Apple Computer, the Solaris Operating System available from Sun Microsystems, Linux available from various sources or UNIX available from various sources. Any of a variety of other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system, and that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems, and that the invention is not limited to any particular distributed architecture, network, or communication protocol.

Various embodiments of the present invention may be programmed using an object-oriented programming language, such as SmallTalk, Java, J# (J-Sharp), C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof. Further, various embodiments of the invention may be implemented using Microsoft®.NET technology available from Microsoft Corporation.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of implementing an automated build process for one or more software applications, the method comprising acts of:
(A) installing, on a computer system, a build process application defining the automated build process, the automated build process comprising:
(i) acquiring source code defining a software application;
(ii) compiling the source code into compiled code defining a build of the software application;
(iii) recording values of build environment parameters at a time of the compiling;
(iv) performing one or more tests on the build to determine whether the build satisfies one or more particular quality thresholds; and
(v) generating a report based on information resulting from at least performance of the acts (iii) and (iv); and
(B) on the computer system, controlling execution of the automated build process for a first software application using the build process application.

2. The method of claim 1, wherein the build process application has one or more user-definable parameters, and the build process application defines a user interface enabling a user to define values for one or more parameters of the automated build process; the method further comprising:
(C) configuring the one or more parameters by executing the user interface.

3. The method of claim 1, wherein the build process application is configured to be capable of executing the automated build process after installation without any manual coding, and
wherein the act (B) is performed after the act (A) without any intervening manual coding of the automated build process.

4. The method of claim 1, wherein the performing of the one or more tests includes performing at least one test corresponding to a version of the source code from which the build was compiled.

5. The method of claim 1, wherein the automated build process defined by the build process application further comprises an act of:
(vi) analyzing the source code and/or the compiled code for one or more particular problems.

6. The method of claim 1, wherein the automated build process defined by the build process application further comprises an act of:
(vi) determining one or more portions of the source code that are tested as part of the act (iv).

7. The method of claim 1, wherein the automated build process defined by the build process application further comprises an act of:
(vi) determining an extent of change between the build and a previous build.

8. The method of claim 1, wherein the automated build process defined by the build process application further comprises an act of:
(vi) updating one or more work item abstractions affected by the build.

9. The method of claim 8, wherein the automated build process defined by the build process application further comprises acts of:
(vii) analyzing the source code and/or the compiled code for one or more particular problems;
(viii) determining one or more portions of the source code that are tested as part of the act (iv); and
(ix) determining an extent of change between the build and a previous build.

10. The method of claim 1, further comprising:
(C) executing, on the computer system, the build process application for a second software application.

11. A system for implementing an automated build process for one or more software applications, the system comprising:
a build process application operative to execute an automated build process comprising: (i) acquiring source code defining a software application, (ii) compiling the source code into compiled code defining a build of the software application, (iii) recording values of build environment parameters at a time of the compiling, (iv) performing one or more tests on the build to determine whether the build satisfies one or more particular quality thresholds, and (v) generating a report based on information resulting from at least performance of the acts (iii) and (iv);
wherein the build process application is configured to be installed and executed on a computer system without any intervening manual coding of the automated build process.

12. The system of claim 11, wherein the build process application has one or more user-definable parameters, and the build process application defines a user interface enabling a user to define values for one or more parameters of the automated build process.

13. The system of claim 11, wherein the automated build process application is operative to perform at least one test corresponding to a version of the source code from which the build was compiled.

14. The system of claim 11, wherein the automated build process defined by the build process application further comprises an act of analyzing the source code and/or the compiled code for one or more particular problems.

15. The system of claim 11, wherein the automated build process defined by the build process application further comprises an act of determining one or more portions of the source code that are tested as part of the act (iv).

16. The system of claim 11, wherein the automated build process defined by the build process application further comprises an act of determining an extent of change between the build and a previous build.

17. The system of claim 11, wherein the automated build process defined by the build process application further comprises an act of updating one or more work item abstractions affected by the build.

18. The system of claim 17, wherein the automated build process defined by the build process application further comprises acts of analyzing the source code and/or the compiled code for one or more particular problems; determining one or more portions of the source code that are tested as part of the act (iv); and determining an extent of change between the build and a previous build.

19. The system of claim 11, wherein the automated build process application is configurable to execute the build process for a plurality of different software applications.

20. A computer program product comprising:
a computer-readable medium; and
computer-readable signals, stored on the computer-readable medium, that define instructions that, as a result of being executed by a computer, control the computer to execute a process of implementing an automated build process for one or more software applications, the process comprising acts of:
(A) installing, on a computer system, a build process application defining the automated build process, the automated build process comprising: (i) acquiring source code defining a software application; (ii) compiling the source code into compiled code defining a build of the software application; (iii) recording values of build environment parameters at a time of the compiling; (iv) performing one or more tests on the build to determine whether the build satisfies one or more particular quality thresholds; and (v) generating a report based on information resulting from at least performance of the acts (iii) and (iv); and
(B) on the computer system, controlling execution of the automated build process for a first software application using the build process application.
